(19) United States
(12) Patent Application Publication
(10) Pub. No.: US 2019/0117336 A1
(43) Pub. Date: Apr. 25, 2019

(54) ROOT CANAL FILL DEVICE

(71) Applicant: William L. Wildey, Hurst, TX (US)

(72) Inventor: William L. Wildey, Hurst, TX (US)

(21) Appl. No.: 15/792,967

(22) Filed: Oct. 25, 2017

(51) Int. Cl. A61C 5/50; A61C 13/30

(52) U.S. Cl. CPC A61C 5/50; A61C 13/30

(57) ABSTRACT

A root canal fill device and method for manufacturing the same is disclosed. The root canal fill device includes a flexible core member coupled to a rigid post member.

### TECHNICAL FIELD

The embodiments relate to root canal procedures, and in particular to a root canal fill device.

### BACKGROUND

As part of a root canal process, a core made up of a flexible material is urged into the root canal of the affected tooth. This core is typically manipulated with a separate rigid device that urges the core into the desired location of the tooth. Due to the flexibility of the core it can be time-consuming and relatively difficult to manipulate the core into the root canal. After the core is properly located in the root canal, a post is then cemented or bonded into place, and dental restorative is packed around the post.

### SUMMARY

The embodiments relate to a root canal fill device that includes a flexible core member that is coupled to a rigid post member. Among other advantages, because the flexible core member is directly coupled to the rigid post member, the flexible core member can be directly and easily manipulated into the correct location of a root canal, and then cemented or otherwise fixed in place.

In one embodiment a root canal fill device is provided. The root canal fill device includes a flexible core member coupled to a rigid post member.

In another embodiment a method for manufacturing a root canal fill device is provided. The method includes forming a flexible core member. The method further includes heating an end portion of the flexible core member to form a softened transition portion. The method further includes inserting into the softened transition portion a rigid post member.

Those skilled in the art will appreciate the scope of the disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1A is a diagram of a root canal fill device in a pre-assembly configuration according to one embodiment;

FIG. 1B is a diagram of the root canal fill device illustrated in FIG. 1A in a post-assembly configuration according to one embodiment;

FIG. 2A is a diagram of a root canal fill device in a pre-assembly configuration according to another embodiment;

FIG. 2B is a diagram of the root canal fill device illustrated in FIG. 2A in a post-assembly configuration according to another embodiment;

FIG. 3A is a diagram of a root canal fill device in a pre-assembly configuration according to yet another embodiment;

FIG. 3B is a diagram of the root canal fill device illustrated in FIG. 3A in a post-assembly configuration according to yet another embodiment;

FIG. 4A is a diagram of the initial positioning of the root canal fill device in a tooth according to one embodiment;

FIG. 4B is a diagram of the root canal fill device in the tooth after a flexible core member has been properly positioned to a final position;

FIG. 5 is a diagram of the initial positioning of the root canal fill device illustrated in FIG. 2B in the tooth; and

FIG. 6 is a flowchart of a method for manufacturing a root canal fill device according to one embodiment.

### DETAILED DESCRIPTION

The embodiments set forth below represent the information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the embodiments are not limited to any particular sequence of steps. The term “about” used herein in conjunction with a numeric value means any value that is within a range of ten percent greater than or ten percent less than the numeric value.

As used herein and in the claims, the articles “a” and “an” in reference to an element refers to “one or more” of the element unless otherwise explicitly specified.

The embodiments relate to a root canal fill device that includes a flexible core member that is coupled to a rigid post member. Among other advantages, because the flexible core member is directly coupled to the rigid post member, the flexible core member can be directly and easily manipulated into the correct location of a root canal. The embodiments also do not require the use of lateral or warm vertical condensation to fill the root canal, each of which can increase the chances of root canal fracture, and each of which increase the time needed to obturate the root canal. The embodiments increase the resistance to root canal fracture and build up the tooth at the same time.

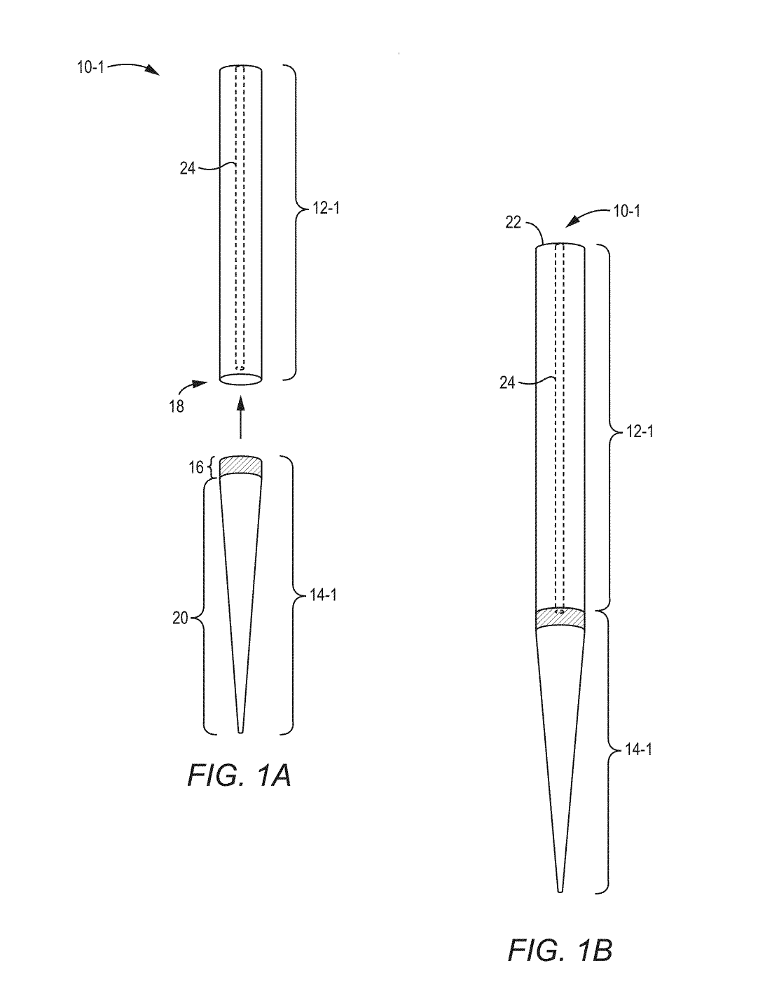

FIG. 1A is a diagram of a root canal fill device 10-1 in a pre-assembly configuration according to one embodiment. The root canal fill device 10-1 includes a rigid post member 12-1 and a flexible core member 14-1. During manufacture, an end portion 16 of the flexible core member 14-1 may be heated thereby softening the end portion 16, and an end portion 18 of the rigid post member 12-1 may be pressed against the softened end portion 16. Upon cooling, the rigid post member 12-1 and the flexible core member 14-1 form a unitary root canal fill device 10-1. In some embodiments, a bonding agent may be used to bond the rigid post member 12-1 to the flexible core member 14-1. In this embodiment, the flexible core member 14-1 is tapered. In some embodiments, the degree of the taper is in a range of 0.1 millimeter (mm) to 5 mm taper per millimeter length.

FIG. 1B is a diagram of the root canal fill device 10-1 in a post-assembly configuration. The rigid post member 12-1 is resistant to bending and may comprise, for example a material such as nickel titanium, titanium, carbon fiber, fiber, stainless steel, combinations of these materials, or other suitable materials. In one embodiment, the rigid post member 12-1 comprises a fibrous material such as gutta percha, or the like. In the embodiment illustrated in FIGS. 1A-1B, the rigid post member 12-1 comprises a cylindrical shape along an entire length of the rigid post member 12-1.

The flexible core member 14-1 comprises a flexible material such as, by way of non-limiting example, gutta percha. In the embodiment illustrated in FIGS. 1A-1B, the flexible core member 14-1 comprises a conical portion 20 that transitions into the cylindrical portion 16. The flexible core member 14-1 may have a length between about 0.1 millimeters (mm) and 20 mm. The flexible core member 14-1 may have a greatest diameter in range between about 0.1 mm and 5 mm.

In some embodiments, the rigid post member 12-1 has a planar top surface 22. In some embodiments the rigid post member 12-1 forms a hollow cylinder 24 that extends longitudinally along a center axis of the rigid post member 12-1. The rigid post member 12-1 may have a length between about 0.1 millimeter and 50 millimeters. The rigid post member 12-1 may have a greatest diameter in a range between about 0.1 mm and 5 mm.

In the embodiment illustrated in FIGS. 1A-1B, the flexible core member 14-1 comprises a cone along an entire length of the flexible core member 14-1, and the rigid post member 12-1 comprises a cylindrical shape along an entire length of the rigid post member 12-1.

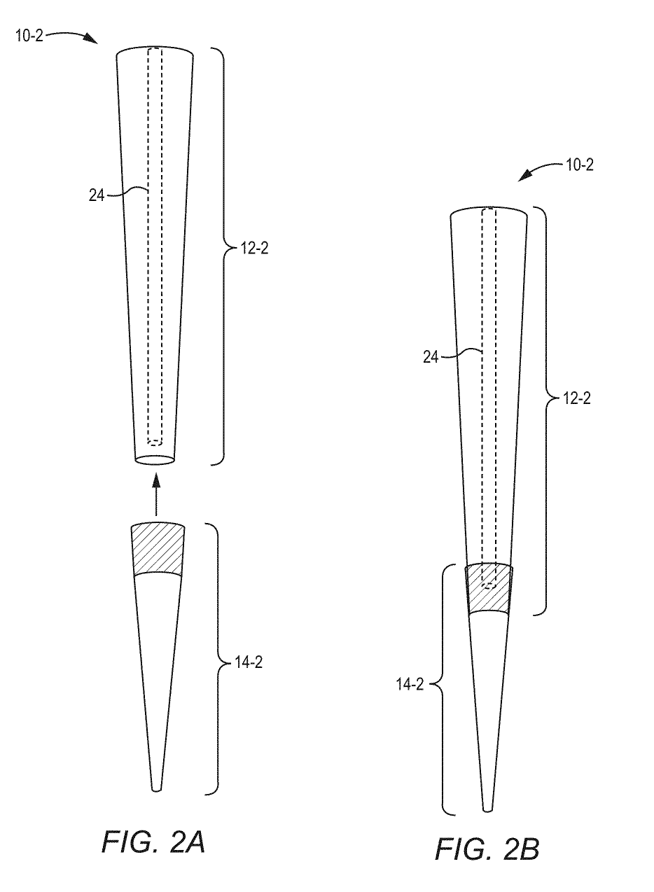

FIG. 2A is a diagram of a root canal fill device 10-2 in a pre-assembly configuration according to another embodiment. The root canal fill device 10-2 includes a rigid post member 12-2 and a flexible core member 14-2. In this embodiment the flexible core member 14-2 comprises a cone along an entire length of the flexible core member 14-2, and the rigid post member 12-2 comprises a conical portion along an entire length of the rigid post member 12-2. FIG. 2B is a diagram of root canal fill device 10-2 in a post-assembly state wherein the flexible core member 14-2 is coupled to the rigid post member 12-2.

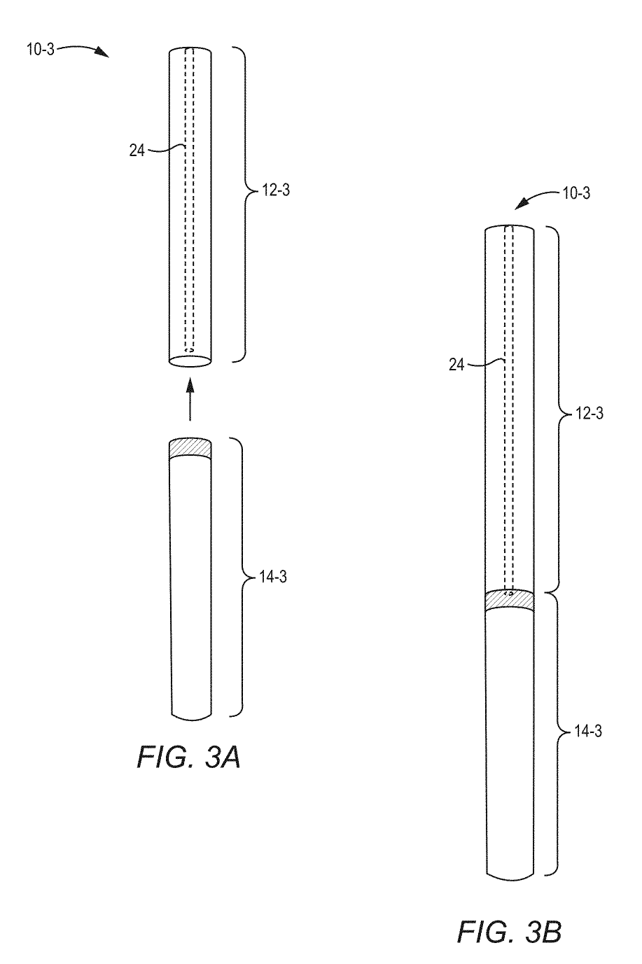

FIG. 3A is a diagram of a root canal fill device 10-3 in a pre-assembly configuration according to yet another embodiment. The root canal fill device 10-3 includes a rigid post member 12-3 and a flexible core member 14-3. In this embodiment, the flexible core member 14-3 comprises a cylinder along an entire length of the flexible core member 14-3, and the rigid post member 12-3 comprises a cylinder along an entire length of the rigid post member 12-3. FIG. 3B is a diagram of the root canal fill device 10-3 in a post-assembly state wherein the flexible core member 14-3 is coupled to the rigid post member 12-3.

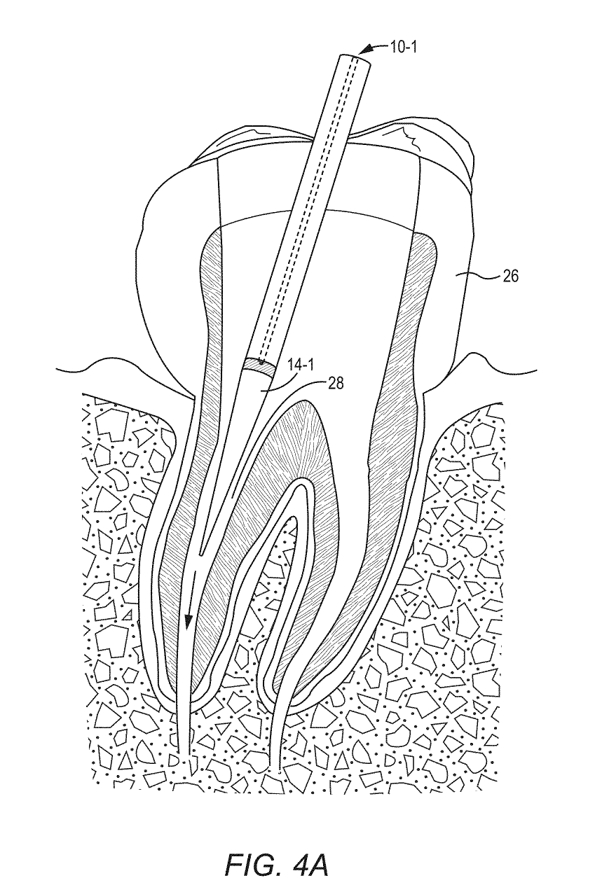

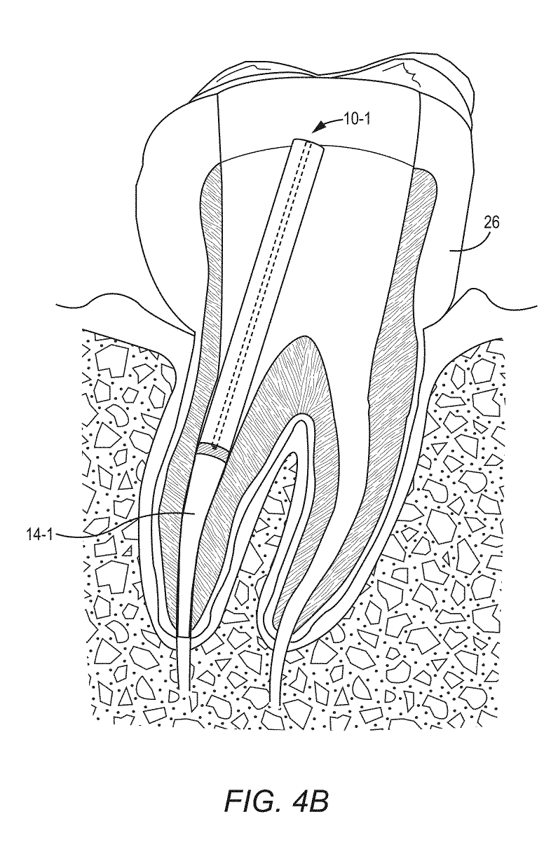

FIG. 4A is a diagram of the initial positioning of the root canal fill device 10-1 in a tooth 26. The flexible core member 14-1 is inserted into a root canal 28. FIG. 4B is a diagram of the root canal fill device 10-1 in the tooth 26 after the flexible core member 14-1 has been properly positioned to a final position.

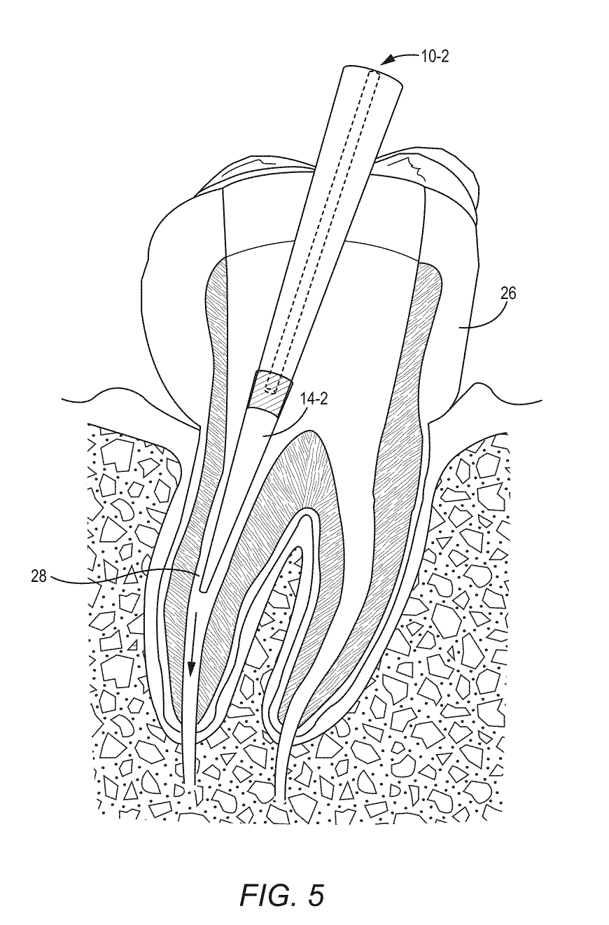

FIG. 5 is a diagram of the initial positioning of the root canal fill device 10-2 in the tooth 26. The flexible core member 14-2 is inserted into the root canal 28.

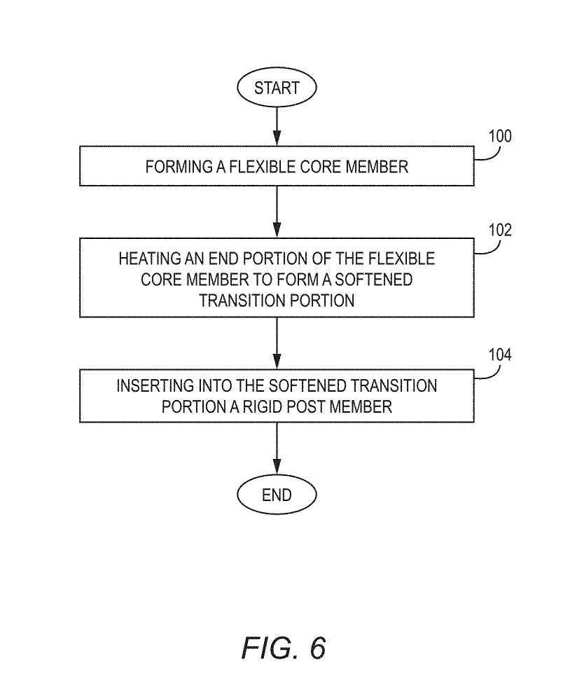

FIG. 6 is a flowchart of a method for manufacturing a root canal fill device according to one embodiment. FIG. 6 will be discussed in conjunction with FIG. 1. Initially, the flexible core member 14-1 is formed (FIG. 6, block 100). The end portion 16 of the flexible core member 14-1 is heated to form a softened transition portion (FIG. 6, block 102). The rigid post member 12-1 is then inserted into the softened transition portion (FIG. 6, block 104). After the softened transition portion cools, the rigid post member 12-1 and the flexible core member 14-1 are coupled via the transition portion and thereby form the unitary root canal fill device 10-1. In some embodiments, in addition to or in lieu of heating either or both of the flexible core member 14-1 and/or the rigid post member 12-1, the flexible core member 14-1 may be glued or bonded together. In another embodiment, the flexible core member 14-1 may be injected molded to the rigid post member 12-1. It will be appreciated that these are merely examples of techniques for coupling the rigid post member 12-1 and the flexible core member 14-1 together, and that other mechanisms/techniques may be used.

Those skilled in the art will recognize improvements and modifications to the preferred embodiments of the disclosure. All such improvements and modifications are considered within the scope of the concepts disclosed herein and the claims that follow.

What is claimed is:

1. A root canal fill device comprising a flexible core member coupled to a rigid post member.

2. The root canal fill device of claim 1 wherein the flexible core member has a conical shape.

3. The root canal fill device of claim 1 wherein the rigid post member comprises a fiber post.

4. The root canal fill device of claim 3 wherein an end of the fiber post has a planar surface.

5. The root canal fill device of claim 3 wherein the fiber post forms a hollow cylinder that extends longitudinally along a center axis of the fiber post.

6. The root canal fill device of claim 1 wherein the flexible core member comprises a cone along an entire length of the flexible core member.

7. The root canal fill device of claim 6 wherein the flexible core member has a taper between about 0.1 mm and 5 mm per mm in length.

8. The root canal fill device of claim 1 wherein the flexible core member comprises a conical portion that transitions into a cylindrical portion, the cylindrical portion coupled to the rigid post member.

9. The root canal fill device of claim 1 wherein the rigid post member comprises a cylindrical shape along an entire length of the rigid post member.

10. The root canal fill device of claim 1 wherein the rigid post member comprises a conical portion that transitions into a cylindrical portion, the conical portion coupled to the flexible core member.

11. The root canal fill device of claim 1 wherein the rigid post member comprises a conical portion along an entire length of the rigid post member.

12. The root canal fill device of claim 1 wherein the flexible core member has a length between about 1 mm and about 20 mm.

13. The root canal fill device of claim 1 wherein the rigid post member has a length between about 1 mm and about 50 mm.

14. The root canal fill device of claim 1 wherein the rigid post member has a diameter between about 0.1 mm and about 5 mm.

15. The root canal fill device of claim 1 wherein the root canal device has a length between about 4 mm and about 30 mm.

16. A method for manufacturing a root canal fill device comprising:
forming a flexible core member;
heating an end portion of the flexible core member to form a softened transition portion; and
inserting into the softened transition portion a rigid post member.

17. The method of claim 16 wherein the flexible core member comprises gutta percha.

18. The method of claim 16 wherein the rigid post member comprises a fiber post.

19. The method of claim 18 wherein the rigid post member forms a hollow cylinder that extends longitudinally along a center axis of the fiber post.

20. The method of claim 16 wherein an end of the rigid post member has a planar surface.
